(19) United States
(12) Patent Application Publication
(10) Pub. No.: US 2013/0139752 A1
(43) Pub. Date: Jun. 6, 2013

(54) ALIGNMENT FILM REPAIRING SYSTEM

(71) Applicant: Yu Song, Shenzhen (CN)

(72) Inventor: Yu Song, Shenzhen (CN)

(21) Appl. No.: 13/502,279

(22) PCT Filed: Dec. 31, 2011
(86) PCT No.: PCT/CN2011/085218

§ 371 Date: Apr. 16, 2012

(30) Foreign Application Priority Data
Dec. 5, 2011 (CN) 201110399191.X

(51) Int. Cl. B05C 5/00; B05C 11/00

(52) U.S. Cl. 118/670; 118/712

(57) ABSTRACT

An alignment film repairing system comprises an inspection device which has a charge coupling device and a defective position detecting circuit, the charge coupling element detects a defective position of an alignment film on a TFT/CF substrate, the defective position detecting circuit records a signal of position coordinate corresponding to the defective position; an alignment film defect elimination device eliminates a defect on the defective position on the TFT/CF substrate based on the signal of position coordinate to form a pin hole; and an alignment film repairing agent coating device coats and repairs the pin hole with an alignment film repairing agent based on the signal of position coordinate.

### FIELD OF THE INVENTION

The present invention relates to a manufacturing technique of liquid crystal display device and more particularly to a repairing technique of alignment film for liquid crystal display.

### BACKGROUND OF THE INVENTION

Referring to FIGS. 1 and 2, in a common liquid crystal panel, a TFT/CF substrate 110 contacted with liquid crystals is coated with a layer of alignment film 120, and the alignment film 120 is used for limiting orientation states of liquid crystal molecules.

During a coating process of the alignment film 120, because a particle 130 is on a surface of the TFT/CF substrate 110, the surface of the TFT/CF substrate 110 is not modifiable, which causes a weak attachability of an alignment solution (PI polyimide solution) on the surface of the TFT/CF substrate 110; and the spreading of the alignment solution on the TFT/CF substrate 110 is affected by the uneven surface of the TFT/CF substrate 110, so that a particle mura is generated on the alignment film 120. After the alignment film 120 is formed by post baking, because images can not be displayed normally at a position of a pin hole 140 (as shown in FIG. 2) which is formed due to removing of the particle 130, the entire alignment film 120 has to be stripped in order before another film can be formed.

A large amount of stripping solution is used for stripping the alignment film 120, and the TFT/CF substrate 110 with the alignment film 120 stripped has to be washed, dried, coated with the alignment solution, pre baked, inspected and hardened before another film can be formed, therefore the manufacturing costs are increased.

### SUMMARY

In order to solve the abovementioned conventional technical problems, the present invention provides an alignment film repairing system by which a particle mura generated during coating of an alignment film and pin holes formed by removing of the particles can be repaired at the designate position, so that the processes of stripping, washing, drying, coating with an alignment solution, pre baking, inspection and hardening of forming another alignment film can be omitted, therefore the manufacturing costs can be reduced.

A technical solution employed by the present invention to solve the abovementioned conventional technical problems includes providing an alignment film repairing system which comprises an inspection device, an alignment film defect elimination device and an alignment film repairing agent coating device. The inspection device comprises a charge coupling device (CCD) and a defective position detecting circuit, the charge coupling device detects a defective position of an alignment film on a TFT/CF substrate, the defective position detecting circuit records a signal of position coordinate corresponding to the defective position. The alignment film defect elimination device eliminates a defect on the defective position on the TFT/CF substrate based on the signal of position coordinate to form a pin hole. The alignment film repairing agent coating device coats and repairs the pin hole with an alignment film repairing agent based on the signal of position coordinate.

In an embodiment of the present invention, the defect is the alignment film with a particle covered.

In an embodiment of the present invention, the pin hole is an indentation formed on the alignment film after the defect is eliminated.

In an embodiment of the present invention, the alignment film defect elimination device is an atmospheric pressure plasma (AP plasma) device.

In an embodiment of the present invention, the alignment film repairing agent coating device is an inkjet device.

In an embodiment of the present invention, when the pin hole is coated with the alignment film repairing agent by the inkjet device, an amount of the alignment film repairing agent dropped by the inkjet device is calculated based on an area of the pin hole, a solid content of the alignment film repairing agent and a targeted film thickness of 100 nm.

In an embodiment of the present invention, the alignment film repairing system further comprises a driver circuit. Movements of the alignment film defect elimination device and the alignment film repairing agent coating device are controlled by the driver circuit. The driver circuit is used for receiving the signal of position coordinate detected by the defective position detecting circuit, and moving the alignment film defect elimination device and the alignment film repairing agent coating device above the defective position, so that the alignment film and the particle at the defective position on the TFT/CF substrate can be eliminated.

In an embodiment of the present invention, the defective pin hole on the alignment film is modified and an attachability of the substrate surface at the defective pin hole area is improved by the alignment film defect elimination device.

Compared with the conventional techniques and according to the alignment film repairing system of the present invention, the alignment film and the particle at the position of the particle mura can be eliminated by the alignment film defect elimination device and the pin hole is formed, or the defective pin hole on the alignment film can be modified and the attachability of the substrate surface at the area of the defective pin hole can be improved by the atmospheric pressure plasma (AP plasma) device, and the pin hole is coated and repaired with the alignment film repairing agent by the inkjet device; the present invention can prevent the problems in conventional techniques of re-forming of another alignment film when defects are generated on the alignment film, which increases manufacturing costs and time.

### BRIEF DESCRIPTION OF THE DRAWINGS

FIG. 1 is an illustration of a conventional coating technique for a liquid crystal alignment film of TFT-LCD;

FIG. 2 is an illustration of a defect of the liquid crystal alignment film of TFT-LCD;

FIG. 3 is a block diagram of elements of an alignment film repairing system of the present invention;

FIG. 4 is an illustration of the alignment film repairing system in FIG. 3;

FIG. 5 is an illustration of a defective position of an alignment film on a TFT/CF substrate being detected by a charge coupling element of the present invention;

FIG. 6 is an illustration of an effect of a defect on the TFT/CF substrate being eliminated by an alignment film defect elimination device of the present invention;

FIG. 7 is an illustration of a pin hole being coated with an alignment film repairing agent by an alignment film repairing agent coating device of the present invention; and

FIG. 8 is an illustration of an effect of the pin hole after being coated with the alignment film repairing agent by the alignment film repairing agent coating device of the present invention.

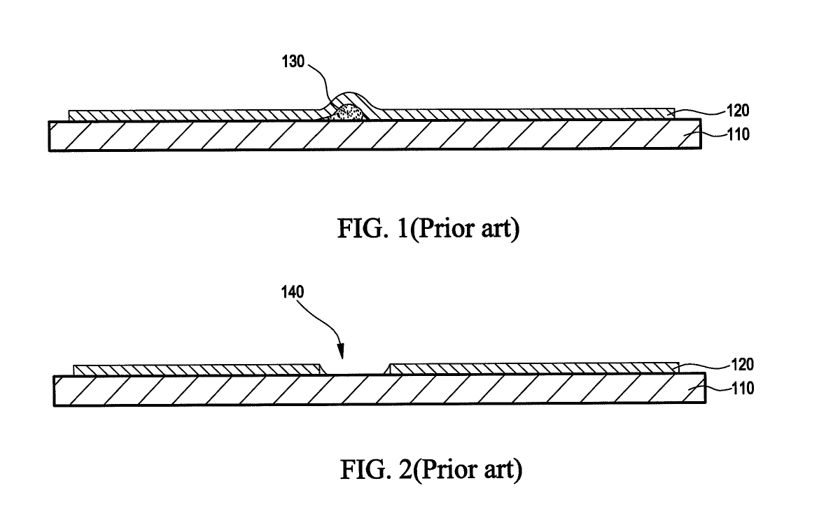

### DETAILED DESCRIPTION OF THE INVENTION

The present invention will become more fully understood by reference to the following detailed description thereof when read in conjunction with the attached drawings.

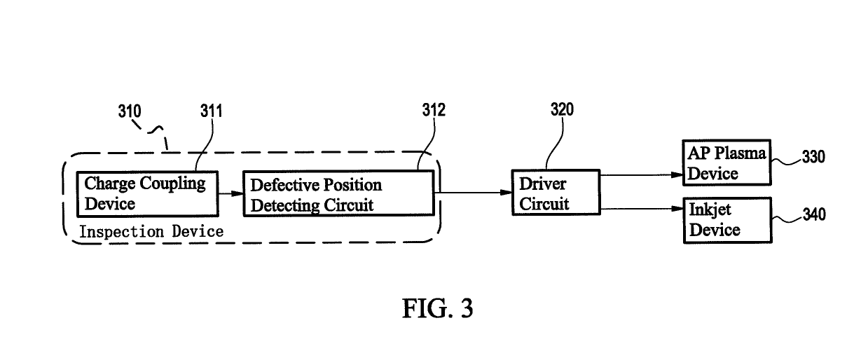

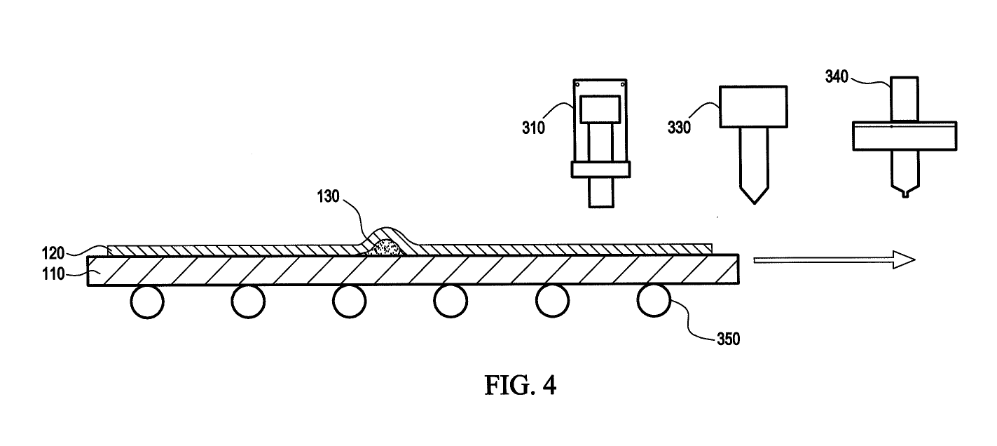

Referring to FIGS. 3 and 4, an alignment film repairing system of the present invention comprises an inspection device 310, a driver circuit 320, an alignment film defect elimination device 330 and an alignment film repairing agent coating device 340. The inspection device 310 comprises a charge coupling device (CCD) 311 and a defective position detecting circuit 312, the charge coupling element 311 detects a defective position of an alignment film on a TFT/CF substrate 110, the defective position detecting circuit 312 records a signal of position coordinate corresponding to the defective position. Movements of the alignment film defect elimination device 330 and the alignment film repairing agent coating device 340 are controlled by the driver circuit 320. The driver circuit 320 is used for receiving the signal of position coordinate detected by the defective position detecting circuit 312, and moving the alignment film defect elimination device 330 and the alignment film repairing agent coating device 340 above the defective position, so that an alignment film 120 and a particle 130 at the defective position on the TFT/CF substrate 110 can be eliminated. Wherein, the TFT/CF substrate 110 is carried on a feeding device 350.

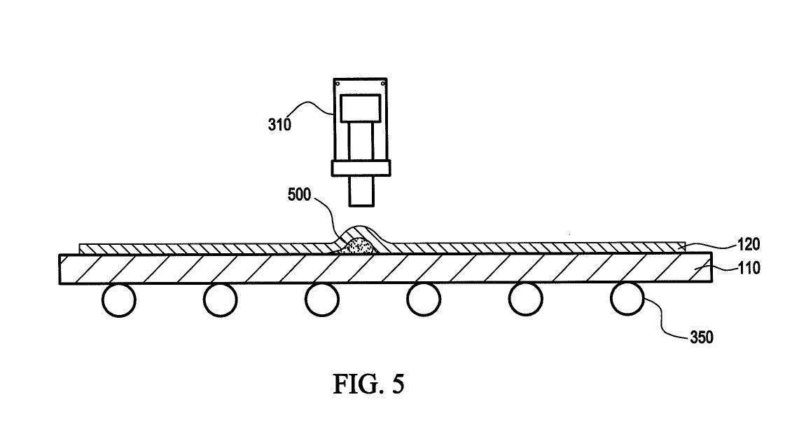

Referring to FIG. 5, a particle mura 500 formed by the particle 130 covered by the alignment film 120 on the TFT/CF substrate 110 is detected by the inspection device 310, and the signal of position coordinate corresponding to the position of the particle mura 500 is recorded by the defective position detecting circuit 312.

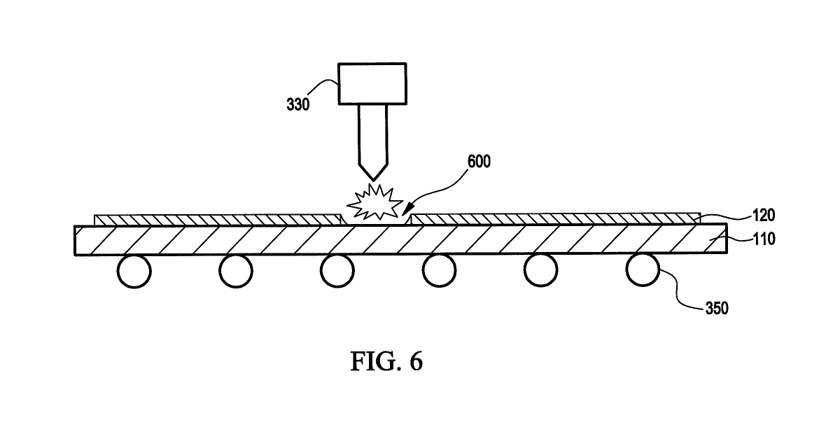

Referring to FIG. 6 and continuing from FIG. 5, preferably, the alignment film defect elimination device 330 is an the atmospheric pressure plasma (AP plasma) device. The atmospheric pressure plasma (AP plasma) device is moved above the particle mura 500 by the driver circuit 320 based on the signal of position coordinate of the particle mura 500 provided by the inspection device 310, so that the alignment film 120 and the particle 130 at the position of the particle mura 500 are eliminated and a pin hole 600 is formed; or the defective pin hole 600 on the alignment film 120 can be modified, and the attachability of the TFT/CF substrate 110 at the area of the defective pin hole 600 can be improved.

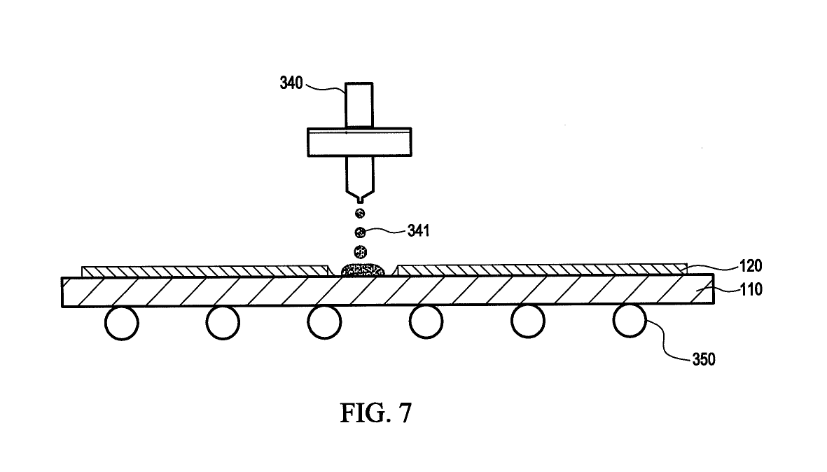

Referring to FIG. 7, preferably, the alignment film repairing agent coating device 340 is an inkjet device. The inkjet device is moved above the particle mura 500 by the driver circuit 320 based on the signal of position coordinate of the particle mura 500 provided by the inspection device 310, and the pin hole 600 is coated and repaired with an alignment film repairing agent 341. The alignment film repairing agent 341 is formed by dissolving the alignment film in a dissolvent. When the pin hole 600 is coated with the alignment film repairing agent 341 by the inkjet device, the best amount of the alignment film repairing agent 341 dropped by the inkjet device is calculated based on an area of the pin hole 600, a solid content of the alignment film repairing agent 341 and a targeted film thickness of 100 nm.

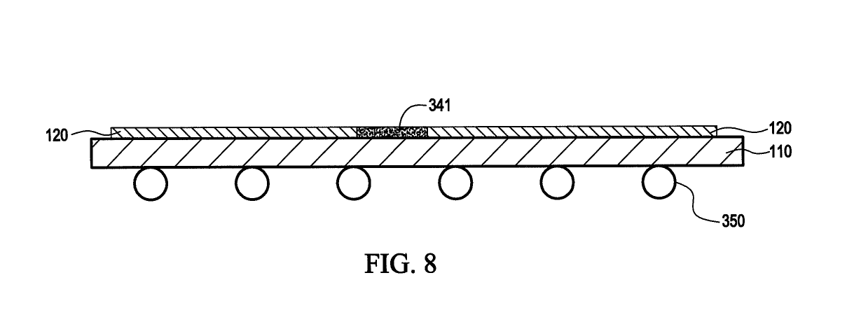

Referring to FIG. 8, the alignment film repairing agent 341 coated in the pin hole 600 is combined with the original alignment film 120.

The alignment film defect elimination device of the present invention is further used for modifying the defective pin hole on the alignment film and improving the attachability of the substrate at the area of the defective pin hole.

Compared with the conventional techniques and according to the alignment film repairing system of the present invention, after the alignment film is formed by the manufacturing procedures of coating, pre baking and hardening, etc., the alignment film is inspected in an inspection procedure if there is particle mura or defective pin hole formed, and the defective positions of the particle mura and pin hole are being detected. Then, by employing the alignment film repairing system, the alignment film and the particle at the position of the particle mura can be eliminated by the atmospheric pressure plasma (AP plasma) device and the pin hole is formed. Or the defective pin hole on the alignment film can be modified and the attachability of the substrate surface at the area of the defective pin hole can be improved by the atmospheric pressure plasma (AP plasma) device. Lastly, the pin hole is coated and repaired with the alignment film repairing agent by the inkjet device; so that the manufacturing costs can be reduced effectively.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. An alignment film repairing system, wherein comprising:
an inspection device having a charge coupling device and a defective position detecting circuit, wherein the charge coupling device detecting a defective position of an alignment film on a TFT/CF substrate, the defective position detecting circuit recording a signal of position coordinate corresponding to the defective position;
an alignment film defect elimination device eliminating a defect on the defective position on the TFT/CF substrate based on the signal of position coordinate to form a pin hole; and
an alignment film repairing agent coating device coating and repairing the pin hole with an alignment film repairing agent based on the signal of position coordinate.

2. The alignment film repairing system of claim 1, wherein the defect is the alignment film with a particle covered.

3. The alignment film repairing system of claim 1, wherein the pin hole is an indentation formed on the alignment film after the defect is eliminated.

4. The alignment film repairing system of claim 1, wherein the alignment film defect elimination device is an atmospheric pressure plasma (AP plasma) device.

5. The alignment film repairing system of claim 1, wherein the alignment film repairing agent coating device is an inkjet device.

6. The alignment film repairing system of claim 5, wherein when the pin hole is coated with the alignment film repairing agent by the inkjet device, an amount of the alignment film repairing agent dropped by the inkjet device is calculated based on an area of the pin hole, a solid content of the alignment film repairing agent and a targeted film thickness of 100 nm.

7. The alignment film repairing system of claim 1, wherein the alignment film repairing system further comprises a driver circuit.

8. The alignment film repairing system of claim 7, wherein movements of the alignment film defect elimination device is controlled by the driver circuit, the driver circuit is used for receiving the signal of position coordinate detected by the defective position detecting circuit, and moving the alignment film defect elimination device above the defective position, so that the alignment film and the particle at the defective position on the TFT/CF substrate can be eliminated.

9. The alignment film repairing system of claim 7, wherein movements of the alignment film repairing agent coating device is controlled by the driver circuit, the driver circuit is used for receiving the signal of position coordinate detected by the defective position detecting circuit, and moving the alignment film repairing agent coating device above the defective position, so that the pin hole can be coated and repaired with the alignment film repairing agent.

10. The alignment film repairing system of claim 1, wherein the alignment film defect elimination device is further used for modifying the defective pin hole on the alignment film and improving an attachability of the substrate at the area of the defective pin hole.
